(19) United States
(12) Patent Application Publication
(10) Pub. No.: US 2024/0401525 A1
(43) Pub. Date: Dec. 5, 2024

(54) GAS TURBINE PLANT WITH AMMONIA DECOMPOSITION SYSTEM

(71) Applicant: DOOSAN ENERBILITY CO., LTD., Changwon-si (KR)

(72) Inventors: Byoung Gu BAK, Suwon-si (KR); Tae Woo KIM, Yongin-si (KR); Hong Geun HA, Yongin-si (KR)

(21) Appl. No.: 18/677,242

(22) Filed: May 29, 2024

(30) Foreign Application Priority Data
May 30, 2023 (KR) 10-2023-0069526
Jul. 11, 2023 (KR) 10-2023-0089993

(51) Int. Cl. F02C 6/18; B01D 53/34; B01D 53/94; F23R 3/28

(52) U.S. Cl. CPC F02C 6/18; B01D 53/343; B01D 53/9431; F23R 3/28; B01D 2257/404; F05D 2220/62

(57) ABSTRACT

The present disclosure relates to a gas turbine plant which decomposes ammonia and supplies it as fuel to a combustor of the gas turbine. The gas turbine plant supplies sufficient heat to the ammonia in order to thermally decompose the ammonia effectively, and separates the residual ammonia present in the decomposition gas and supplies it to a combustor of the gas turbine.

### CROSS-REFERENCE TO RELATED APPLICATIONS

The present application claims the benefit of priority to Korea Patent Application No. 10-2023-0069526, filed May 30, 2023, and Korea Patent Application No. 10-2023-0089993, filed Jul. 11, 2023, the entire contents of which are incorporated herein for all purposes by this reference.

### FIELD

The present disclosure relates to a gas turbine plant with an ammonia decomposition system and more particularly to a gas turbine plant which decomposes ammonia and supplies it as fuel to a combustor of the gas turbine.

### BACKGROUND

For the purpose of reducing the emission amount of carbon dioxide in order to preserve global environment, it is a promising option to use hydrogen as a fuel which does not emit carbon dioxide even when combusted. However, compared to a fuel such as liquefied natural gas which is widely used as a fuel for a gas turbine, hydrogen is not easy to transport or store.

Therefore, it is being considered that ammonia that can be converted to hydrogen is used as a fuel.

Japanese Patent No. 2948351 discloses a gas turbine plant equipped with a decomposition device that heats ammonia and decomposes it into hydrogen and nitrogen. The decomposition device of the gas turbine plant heats ammonia by performing heat exchange between liquid ammonia with pressure increased by a pressure pump and exhaust gas discharged from the gas turbine, thereby thermally decomposing the ammonia into decomposition gas containing hydrogen and nitrogen. This decomposition gas is supplied as it is to a combustor of the gas turbine.

However, the liquid ammonia may not be sufficiently heated by the exhaust gas. In this case, a large amount of ammonia in addition to hydrogen and nitrogen often remains in the decomposition gas. When the decomposition gas is supplied to the combustor of the gas turbine and the residual ammonia is combusted, there is a problem that a large amount of nitrogen oxides (NOx) is generated.

### SUMMARY

The purpose of the present disclosure is to provide a gas turbine plant that decomposes ammonia and supplies it as fuel to a combustor of a gas turbine. The gas turbine plant supplies sufficient heat to the ammonia in order to thermally decompose the ammonia effectively, and separates the residual ammonia present in the decomposition gas and supplies it to a combustor of the gas turbine.

The technical problem to be overcome in this document is not limited to the above-mentioned technical problems. Other technical problems not mentioned can be clearly understood from those described below by a person having ordinary skill in the art.

One embodiment is a gas turbine plant with an ammonia decomposition system. The gas turbine plant includes: a storage tank configured to store liquid ammonia; a supply pump configured to supply the liquid ammonia of the storage tank; a preheater configured to preheat the liquid ammonia supplied by the supply pump; a vaporizer configured to vaporize the liquid ammonia preheated by the preheater; a superheater configured to superheat the gaseous ammonia vaporized by the vaporizer; a decomposition reactor configured to thermally decompose the gaseous ammonia superheated by the superheater; a separator configured to separate residual ammonia from the decomposition gas decomposed by the decomposition reactor; and a first combustor configured to generate combustion gas in such a way as to supply heat to the decomposition reactor. Synthesis gas consisting of hydrogen and nitrogen with the residual ammonia removed by the separator is supplied to a second combustor of a gas turbine. Exhaust gas that is discharged from the gas turbine is supplied to a heat recovery steam generator, steam generated by heat of the exhaust gas in the heat recovery steam generator is supplied to a steam turbine and drives the steam turbine, and then flows into a condenser, and the water condensed in the condenser is supplied back to the heat recovery steam generator. The water or steam extracted from the heat recovery steam generator or downstream of the condenser receives heat from the decomposition gas in a first heat exchanger, and then is recovered to the heat recovery steam generator or upstream of the steam turbine.

The steam recovered upstream of the steam turbine may join the steam generated in the heat recovery steam generator and may be supplied to the steam turbine.

The gas turbine plant may further include a booster compressor that increases a pressure of the steam extracted from the heat recovery steam generator and supplies the steam to the first heat exchanger.

The gas turbine plant may further include a sprayer for spraying water on the steam supplied to the first heat exchanger when the steam extracted from the heat recovery steam generator is supplied to the first heat exchanger.

The sprayer may spray a portion of the water condensed in the condenser on the steam supplied to the first heat exchanger.

The gas turbine plant may further include a booster pump that increases a pressure of the water extracted from the heat recovery steam generator and supplies the water to the first heat exchanger.

The water or steam discharged after receiving heat in the first heat exchanger may receive additional heat from the decomposition gas in a second heat exchanger.

The decomposition gas discharged from the decomposition reactor may pass through the first heat exchanger and then may pass through the second heat exchanger.

The gas turbine plant may further include a third heat exchanger in which heat exchange occurs between the combustion gas and an oxidant supplied to the first combustor.

The gas turbine plant may further include a fourth heat exchanger in which heat exchange occurs between the oxidant and water or steam heated by the heat of the exhaust gas in the heat recovery steam generator.

The oxidant may pass through the fourth heat exchanger and the third heat exchanger in turn, and then may be supplied to the first combustor.

Water or steam extracted from the heat recovery steam generator to the fourth heat exchanger may be recovered back to the heat recovery steam generator or downstream of the condenser.

Water or steam heated by the heat of the exhaust gas in the heat recovery steam generator may supply heat to the liquid ammonia or the gaseous ammonia.

The separator may include: an ammonia absorption tower that separates the residual ammonia included in the decomposition gas by dissolving the residual ammonia in water; and an ammonia regeneration tower that evaporates and regenerates ammonia from ammonia water generated by dissolving the residual ammonia in water in the ammonia absorption tower. A portion of the water discharged from the ammonia regeneration tower may be supplied to the ammonia absorption tower, and the rest of the water may be vaporized through a reboiler and may be supplied back to the ammonia regeneration tower. Water or steam heated by the heat of the exhaust gas in the heat recovery steam generator may supply heat to the water passing through the reboiler.

The decomposition gas that has passed through the first heat exchanger may supply heat to the liquid ammonia or the gaseous ammonia.

A portion of the exhaust gas may be supplied as an oxidant to the first combustor.

The combustion gas may join the exhaust gas within the heat recovery steam generator.

The combustion gas may join an upstream side of a selective catalytic reduction device of the heat recovery steam generator.

The water or steam extracted from the heat recovery steam generator or downstream of the condenser may receive heat from the combustion gas in a fifth heat exchanger, and then may be recovered to the heat recovery steam generator or upstream of the steam turbine.

Another embodiment is a gas turbine plant with an ammonia decomposition system. The gas turbine plant includes: a storage tank configured to store liquid ammonia; a supply pump configured to supply the liquid ammonia of the storage tank; a preheater configured to preheat the liquid ammonia supplied by the supply pump; a vaporizer configured to vaporize the liquid ammonia preheated by the preheater; a superheater configured to superheat the gaseous ammonia vaporized by the vaporizer; a decomposition reactor configured to thermally decompose the gaseous ammonia superheated by the superheater; a separator configured to separate residual ammonia from the decomposition gas decomposed by the decomposition reactor; and a first combustor configured to generate combustion gas in such a way as to supply heat to the decomposition reactor. Synthesis gas consisting of hydrogen and nitrogen with the residual ammonia removed by the separator is supplied to a second combustor of a gas turbine. Exhaust gas that is discharged from the gas turbine is supplied to a heat recovery steam generator, steam generated by heat of the exhaust gas in the heat recovery steam generator is supplied to a steam turbine and drives the steam turbine, and then flows into a condenser, and the water condensed in the condenser is supplied back to the heat recovery steam generator. The water or steam extracted from the heat recovery steam generator or downstream of the condenser receives heat from the combustion gas in a fifth heat exchanger and then is supplied to a first heat exchanger, and receives heat from the decomposition gas in the first heat exchanger and then is recovered to the heat recovery steam generator or upstream of the steam turbine.

According to the embodiment, the ammonia decomposition system includes the preheater, the vaporizer, and the superheater, which heat ammonia prior to the decomposition reactor. The combustion gas generated by the first combustor supplies heat to the decomposition reactor. Accordingly, sufficient heat can be supplied to the ammonia and the ammonia can be thermally decomposed effectively at a high temperature.

Also, the water or steam extracted from the heat recovery steam generator or downstream of the condenser receives heat from the decomposition gas in one or more heat exchangers and then is recovered to the heat recovery steam generator or upstream of the steam turbine, so that the heat of the decomposition gas can be effectively recovered.

Also, when the combustion gas and the oxidant supplied to the first combustor exchange heat, a heat source of the combustion gas remaining after supplying heat to the decomposition reactor can be effectively recovered. Also, as the oxidant is heated, the amount of fuel used for a target temperature of the combustion gas in the first combustor can be reduced.

Also, when the water or steam heated in the heat recovery steam generator is used as a heat source for supplying heat to the liquid ammonia or the gaseous ammonia, the efficiency of the plant can be enhanced.

Also, when the water or steam heated in the heat recovery steam generator is used to heat water in the reboiler, the efficiency of the plant can be enhanced.

Also, the water or steam extracted from the heat recovery steam generator or downstream of the condenser receives heat from the combustion gas in one or more heat exchangers and then is recovered to the heat recovery steam generator or upstream of the steam turbine. As a result, the heat source of the combustion gas remaining after supplying heat to the decomposition reactor can be effectively recovered.

The effect of the present disclosure is not limited to the above effects and should be construed as including all the effects that can be inferred from the configuration of the present disclosure disclosed in the detailed description or claims of the present disclosure.

### BRIEF DESCRIPTION OF THE DRAWINGS

FIG. 1 is a schematic diagrams of a gas turbine plant with an ammonia decomposition system according to an embodiment;

FIG. 2 is a schematic diagram of a gas turbine plant with an ammonia decomposition system according to an embodiment;

FIG. 3 is a schematic diagram of a gas turbine plant with an ammonia decomposition system according to an embodiment;

FIG. 4 is a schematic diagram of a gas turbine plant with an ammonia decomposition system according to an embodiment;

FIG. 5 is a schematic diagram of a gas turbine plant with an ammonia decomposition system according to an embodiment;

FIG. 6 is a schematic diagram of a gas turbine plant with an ammonia decomposition system according to an embodiment;

FIG. 7 is a schematic diagram of a gas turbine plant with an ammonia decomposition system according to an embodiment;

FIG. 8 is a schematic diagram of a gas turbine plant with an ammonia decomposition system according to an embodiment;

FIG. 9 is a schematic diagram of a gas turbine plant with an ammonia decomposition system according to an embodiment; and

FIG. 10 is a schematic diagram of a gas turbine plant with an ammonia decomposition system according to an embodiment.

### DETAILED DESCRIPTION

Hereinafter, preferable embodiments of a gas turbine plant with an ammonia decomposition system will be described with reference to accompanying drawings.

Also, the below-mentioned terms are defined in consideration of the functions in the present disclosure and may be changed according to the intention of users or operators or custom. The following embodiments do not limit the scope of the present disclosure and are merely exemplary of the components presented in the claims of the present disclosure.

Parts irrelevant to the description will be omitted for a clear description of the present disclosure. The same or similar reference numerals will be assigned to the same or similar components throughout this specification. Throughout this specification, when it is mentioned that a portion “includes” an element, it means that the portion does not exclude but further includes other elements unless there is a special opposite mention.

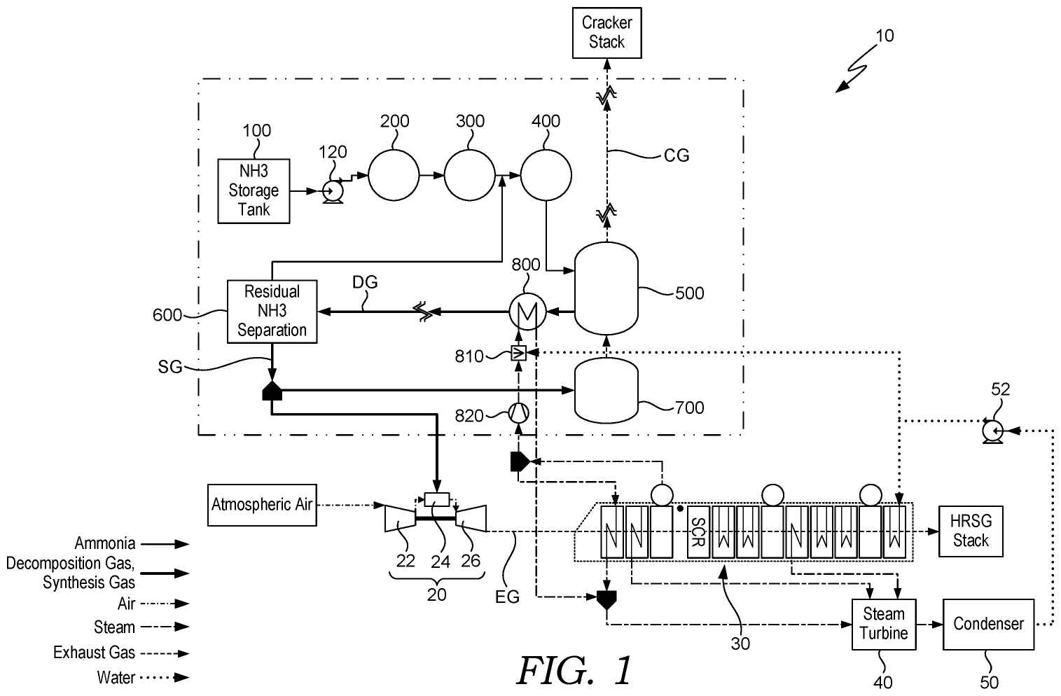

First, a gas turbine plant including an ammonia decomposition system according to an embodiment of the present disclosure will be described with reference to FIG. 1.

The gas turbine plant according to the embodiment generally includes an ammonia decomposition system 10, a gas turbine 20, a heat recovery steam generator (HRSG) 30, a steam turbine 40, and a condenser 50.

The ammonia decomposition system 10 includes a storage tank 100, a supply pump 120, a preheater 200, a vaporizer 300, a superheater 400, a decomposition reactor 500, a separator 600, and a first combustor 700.

The gas turbine 20 includes a compressor 22 for compressing air to high pressure, a second combustor 24 for mixing the air compressed by the compressor 22 with fuel and for combusting, and a turbine 26 for generating power while rotating turbine blades by using high-temperature and high-pressure combustion gas discharged from the second combustor 24.

In the embodiment of the present disclosure, synthesis gas based on hydrogen decomposed in the ammonia decomposition system 10 as a main component is supplied as fuel for the second combustor 24. It is shown in the drawing that only the synthesis gas is supplied. However, in some cases, it is also possible that the synthesis gas and natural gas are supplied to the second combustor 24 together and mixed and combusted.

Exhaust gas (EG) discharged from the turbine 26 of the gas turbine 20 is supplied to the heat recovery steam generator 30 and vaporizes water into steam within the heat recovery steam generator 30. The steam generated by heat of the exhaust gas (EG) in the heat recovery steam generator 30 is supplied to the steam turbine 40 and drives the steam turbine to produce electric power. After driving the steam turbine 40, the steam flows into the condenser 50 and is condensed by cooling water, and the water condensed in the condenser 50 is supplied back to the heat recovery steam generator 30. There may be provided a condensate pump 52 which supplies the water condensed in the condenser 50 to the heat recovery steam generator 30.

Hereinafter, each component of the ammonia decomposition system 10 will be described in detail. FIG. 1 shows a flow of ammonia or ammonia-decomposed gas passing through the components of the ammonia decomposition system 10, and adjacent components will be connected to each other through connection pipes, etc.

The storage tank 100 stores liquid ammonia, and the supply pump 120 increases the pressure of the liquid ammonia of the storage tank 100 and supplies the liquid ammonia to the preheater 200.

Subsequently, the preheater 200, the vaporizer 300, and the superheater 400 are configured to vaporize and heat the liquid ammonia prior to the decomposition reactor 500. Specifically, the preheater 200 preheats the liquid ammonia supplied by the supply pump 120. The vaporizer 300 vaporizes the liquid ammonia preheated by the preheater 200. The superheater 400 superheats the gaseous ammonia vaporized by the vaporizer 300.

As one example, when the supply pump 120 increases the pressure of the liquid ammonia to 40 atm, a boiling point of the ammonia at 40 atm is around 100° C. In this case, the preheater 200 heats the liquid ammonia to below the boiling point, and the vaporizer 300 heats the liquid ammonia to the boiling point and generates gaseous ammonia. The superheater 400 additionally heats the gaseous ammonia.

The decomposition reactor 500 thermally decomposes the gaseous ammonia superheated by the superheater 400 and generates decomposition gas (DG) containing hydrogen, nitrogen, and residual ammonia. A catalyst that promotes the thermal decomposition of the ammonia may be filled in the decomposition reactor 500. The catalyst has a catalyst component that activates a decomposition reaction, and a carrier that supports the catalyst component. An example of the catalyst component includes particles of precious metal such as Ru, etc., and metal particles including transition metals such as Ni, Co, and Fe, etc. The carrier includes a metal oxide such as Al2O3, ZrO2, Pr2O3, La2O3, MgO, etc. The catalyst is not limited to the catalysts exemplified above as long as the catalyst activates the decomposition reaction of ammonia.

The separator 600 separates residual ammonia from the decomposition gas (DG) decomposed by the decomposition reactor 500. Then, the residual ammonia is removed in the separator 600, the synthesis gas (SG) consisting of hydrogen and nitrogen is supplied to the second combustor 24 of the gas turbine. Here, the residual ammonia separated by the separator 600 may be mixed with the gaseous ammonia vaporized by the vaporizer 300 and may be supplied to the superheater 400. Since ammonia is highly soluble in water, the separator 600 can remove the residual ammonia by dissolving the residual ammonia in water. Also, ammonia is easier to evaporate than water. Therefore, when ammonia water that is obtained by dissolving the residual ammonia in water is heated, gaseous ammonia can be separated again.

Here, a reaction temperature for the thermal decomposition of the ammonia (depending on the catalyst, generally 400° C. to 700° C.) is much higher than a boiling point of ammonia. Therefore, the decomposition reactor 500 requires a relatively high temperature heat source. To this end, the ammonia decomposition system 10 includes the first combustor 700 that generates combustion gas (CG) such that heat is supplied to the decomposition reactor 500. In the embodiment, the combustion gas (CG) generated by the first combustor 700 supplies heat while passing through the decomposition reactor 500. Also, in some cases, the combustion gas (CG) may pass through the preheater 200, the vaporizer 300, or the superheater 400.

The combustion gas (CG) generated from the first combustor 700 generally has a temperature of about 1000° C., which is higher than that of the exhaust gas (EG) discharged from the gas turbine 20. Therefore, by using the combustion gas (CG) with the inclusion of the separate first combustor 700, the ammonia can be effectively thermally decomposed by the decomposition reactor 500 even without using a high-performance catalyst, and the efficiency of the decomposition reactor 500 can be improved.

As such, the ammonia decomposition system 10 may include the preheater 200, the vaporizer 300, and the superheater 400, which are for heating the ammonia before the decomposition reactor 500, and the combustion gas (CG) generated by the first combustor 700 supplies heat to the decomposition reactor 500. Accordingly, sufficient heat can be supplied to the ammonia and the ammonia can be thermally decomposed effectively.

Accordingly, there is not much residual ammonia in the decomposition gas (DG), and the residual ammonia is reliably removed through the separator 600 and the decomposition gas (DG) is supplied to the second combustor 24, thereby reducing nitrogen oxides in the exhaust gas (EG).

Separate fuel such as fossil fuel may be supplied to the first combustor 700. However, it is desirable that a portion of the decomposition gas (DG) or synthesis gas (SG) and the ammonia present in the ammonia decomposition system 10 should be supplied as fuel to the first combustor 700 in order that the system is simplified and carbon dioxide is not emitted. In the embodiment, a portion of the synthesis gas (SG) with the residual ammonia removed by the separator 600 is supplied to the first combustor 700 and is combusted. As such, a portion of the synthesis gas (SG) is supplied as fuel to the first combustor 700, so that no separate fuel such as fossil fuel is required. Although not shown, the first combustor 700 may also be supplied with an oxidant for combustion.

In the embodiment of the present disclosure, water or steam extracted from the heat recovery steam generator 30 or downstream of the condenser 50 receives heat from the decomposition gas (DG) in a first heat exchanger 800, and then is recovered back to the heat recovery steam generator 30 or upstream of the steam turbine 40. That is, the condensed water may be extracted downstream of the condenser 50, or the water or steam may be extracted from various locations within the heat recovery steam generator 30, and may flow into the first heat exchanger 800. In addition, the water or steam discharged after being heated in the first heat exchanger 800 may be recovered to various locations within the heat recovery steam generator 30, or the steam discharged after being heated in the first heat exchanger 800 may be recovered upstream of the steam turbine 40. As a result, the heat of decomposition gas (DG) can be effectively recovered.

FIG. 1 shows that the steam extracted from the heat recovery steam generator 30 flows into the first heat exchanger 800 and the steam additionally heated by the decomposition gas (DG) in the first heat exchanger 800 is recovered upstream of the steam turbine 40. The steam recovered upstream of the steam turbine 40 joins the steam generated in the heat recovery steam generator 30 and enters the steam turbine 40.

As such, when the steam extracted from the heat recovery steam generator 30 is supplied to the first heat exchanger 800, the temperature of the first heat exchanger 800 may become too high. This adversely affects a metal material. Therefore, in order to prevent the temperature of the first heat exchanger 800 from becoming too high, a sprayer 810 for spraying water on the steam supplied to the first heat exchanger 800 may be provided. In the embodiment, the sprayer 810 brings a portion of the water condensed in the condenser 50 and sprays it on the steam supplied to the first heat exchanger 800.

Also, a booster compressor 820 that increases the pressure of the steam extracted from the heat recovery steam generator 30 and supplies it to the first heat exchanger 800 may be further provided.

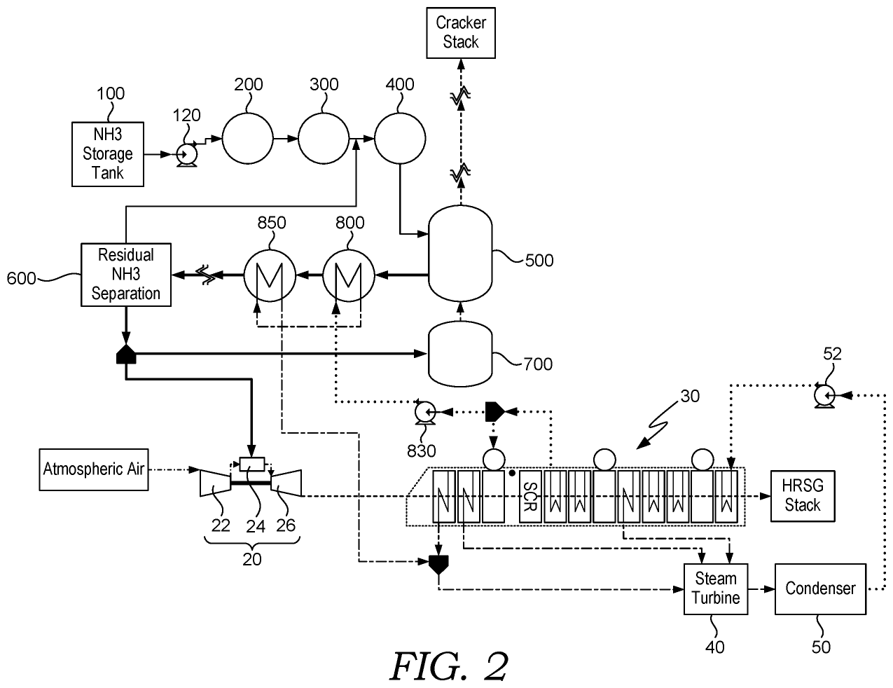

Next, unlike the first embodiment, in the embodiment shown in FIG. 2, the water extracted from the heat recovery steam generator 30 flows into the first heat exchanger 800, and a second heat exchanger 850 is further included.

Specifically, the water extracted from the heat recovery steam generator 30 flows into the first heat exchanger 800. In this case, a booster pump 830 may be provided, which increases the pressure of the water extracted from the heat recovery steam generator 30 and supplies the water to the first heat exchanger 800.

The water or steam discharged after receiving heat from the decomposition gas (DG) in the first heat exchanger 800 receives additional heat from the decomposition gas (DG) in the second heat exchanger 850. As shown in FIG. 2, the water extracted from the heat recovery steam generator 30 is vaporized by receiving heat from the first heat exchanger 800, and the steam discharged from the first heat exchanger 800 is additionally heated in the second heat exchanger 850, and then is recovered upstream of the steam turbine 40. Here, it is desirable that the second heat exchanger 850 is disposed downstream of the first heat exchanger 800 in the flow of the decomposition gas (DG). That is, the decomposition gas (DG) discharged from the decomposition reactor 500 passes through the first heat exchanger 800 and then passes through the second heat exchanger 850. Since the decomposition gas (DG) is at a high temperature, the first heat exchanger 800, which is more advantageous for controlling the metal temperature due to the evaporation of water, is disposed at a higher temperature portion than the second heat exchanger 850.

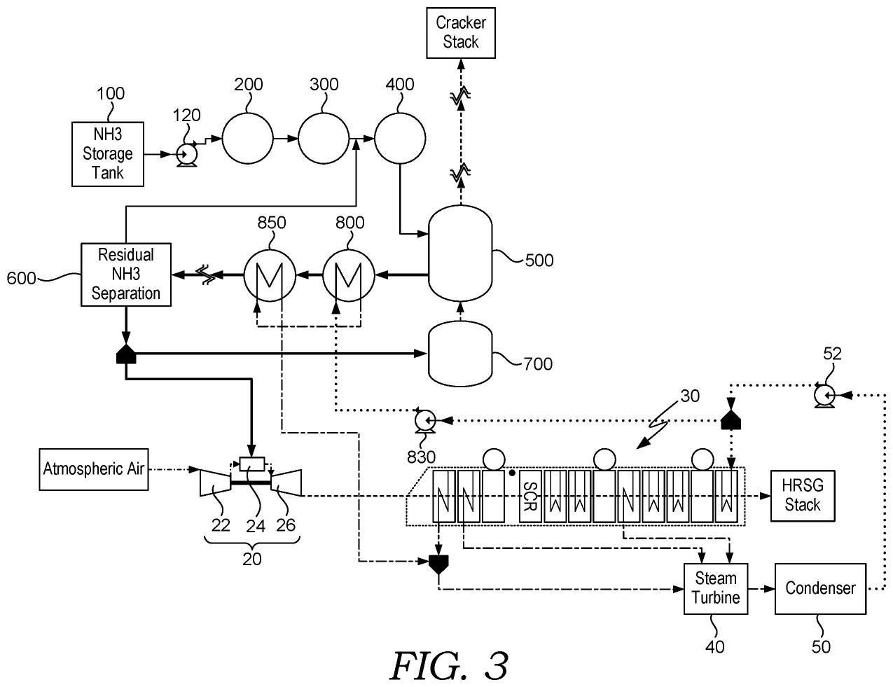

According to the embodiment shown in FIG. 3, unlike the embodiment shown in FIG. 2, a portion of the water condensed in the condenser 50 is extracted downstream of the condenser 50 and flows into the first heat exchanger 800.

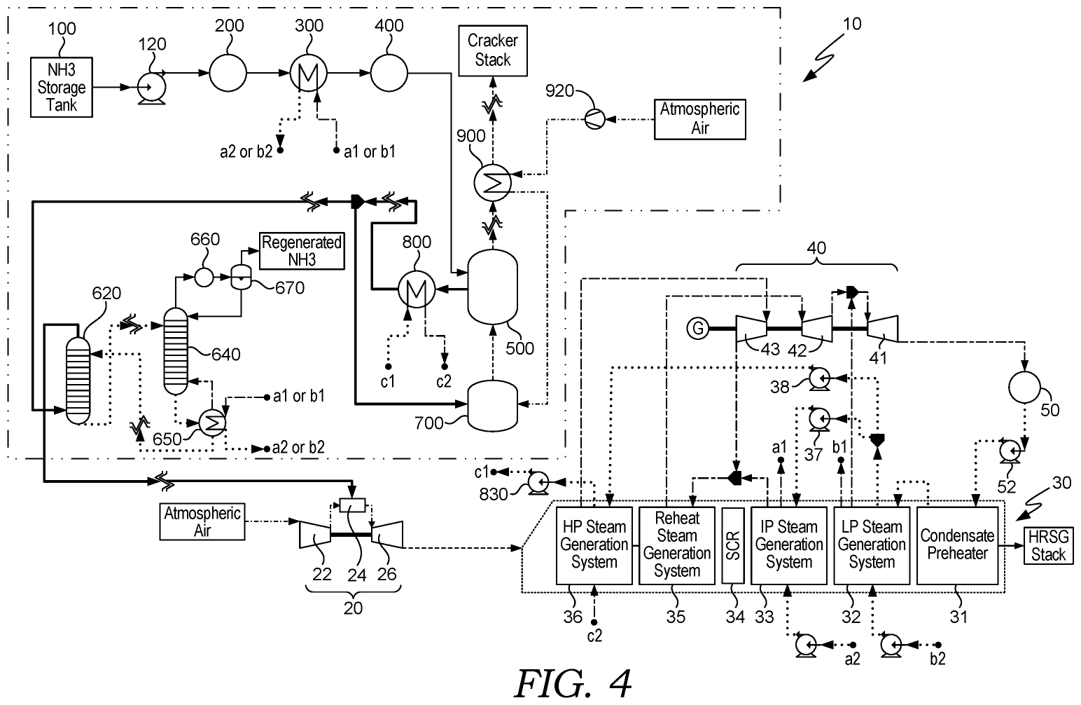

Next, a gas turbine plant including an ammonia decomposition system according to another embodiment of the present disclosure will be described with reference to FIG. 4.

Likewise, the gas turbine plant of the embodiment also generally includes the ammonia decomposition system 10, the gas turbine 20, the heat recovery steam generator 30, the steam turbine 40, and the condenser 50. Hereinafter, the following description will focus on only differences from the embodiment shown in FIG. 1. The components identical to the components of FIG. 1 are denoted by the same reference numerals.

In FIG. 4, the heat recovery steam generator 30 and the steam turbine 40 are shown in more detail. Specifically, the heat recovery steam generator 30 includes a condensate preheater 31 for preheating condensate, a low-pressure steam generation system 32 for generating low-pressure steam, an intermediate-pressure steam generation system 33 for generating intermediate-pressure steam, a selective catalytic reduction (SCR) device 34, a reheat steam generation system 35 for generating reheat steam, and a high-pressure steam generation system 36 for generating high-pressure steam. The low-pressure steam generation system 32 may include an evaporator that evaporates condensate preheated by the condensate preheater 31 into steam and a superheater that superheats the steam. The intermediate-pressure steam generation system 33 may include an economizer that preheats water supplied through an intermediate-pressure pump 37, an evaporator that evaporates the preheated water into steam, and a superheater that superheats the steam. The high-pressure steam generation system 36 may also include an economizer that preheats water supplied through a high-pressure pump 38, an evaporator that evaporates the preheated water into steam, and a superheater that superheats the steam.

The high-pressure steam generated by the high-pressure steam generation system 36 is supplied to a high-pressure turbine 43 and generates a rotational force, and the steam with reduced energy is then supplied to the reheat steam generation system 35 for reheating. The steam from the high-pressure turbine 43 is mixed with the intermediate-pressure steam generated by the intermediate-pressure steam generation system 33 and is heated again in the reheat steam generation system 35. The steam heated in the reheat steam generation system 35 is supplied to an intermediate-pressure turbine 42 and generates a rotational force, and the steam with reduced energy is then mixed with the low-pressure steam generated by the low-pressure steam generation system 32 and is supplied to a low-pressure turbine 41. The steam from the low-pressure turbine 41 flows into the condenser 50. As such, the low-pressure steam, the intermediate-pressure steam, and the high-pressure steam generated in the heat recovery steam generator 30 are supplied to the low-pressure turbine 41, the intermediate-pressure turbine 42, and the high-pressure turbine 43, respectively, so that a rotational force is generated and electricity is generated by the rotational force.

Besides, the structure of the separator 600 is also shown in more detail. Briefly, the separator 600 may include an ammonia absorption tower 620, an ammonia regeneration tower 640, a reboiler 650, a condenser 660, and a separation tank 670. The ammonia absorption tower 620 separates the residual ammonia included in the decomposition gas (DG) by dissolving the residual ammonia in water. The hereby formed synthesis gas (SG) is supplied to the second combustor 24 of the gas turbine, and ammonia water is supplied to the ammonia regeneration tower 640. The ammonia regeneration tower 640 evaporates and regenerates ammonia from the ammonia water through water vapor. The regenerated gaseous ammonia may be cooled and condensed by a predetermined amount while passing through the condenser 660. The separation tank 670 serves to separate the liquid ammonia condensed in the condenser 660 from the uncondensed gaseous ammonia by a density difference. The liquid ammonia separated by the separation tank 670 may be recovered back to the ammonia regeneration tower 640. The remaining water after the evaporation of the ammonia from the ammonia water and the water resulting from the condensation of the water vapor are discharged from the ammonia regeneration tower 640, some of which are supplied to the ammonia absorption tower 620, and the rest of which is vaporized into water vapor while passing through the reboiler 650 and is circulated back to the ammonia regeneration tower 640.

Also, in the embodiment, it is shown that a portion of the decomposition gas (DG) decomposed in the decomposition reactor 500, instead of a portion of the synthesis gas (SG), is supplied to the first combustor 700.

The embodiment shows a structure in which water flows from the high-pressure steam generation system 36 to the first heat exchanger 800 through the booster pump 830 (c1) and high-pressure steam heated by the decomposition gas (DG) in the first heat exchanger 800 is recovered back to the high-pressure steam generation system 36 (c2). However, the embodiment is not limited to this, and a location where the water or steam flowing into the first heat exchanger 800 is extracted, a location where the water or steam discharged from the first heat exchanger 800 is recovered, etc., may be changed. As seen in FIG. 2, the second heat exchanger 850 may be additionally provided.

Furthermore, the ammonia decomposition system 10 of the embodiment is further provided with a third heat exchanger 900 in which heat exchange occurs between the combustion gas (CG) and the oxidant supplied to the first combustor 700. Since the third heat exchanger 900 is disposed downstream of the decomposition reactor 500 in the flow of the combustion gas (CG), the oxidant and the combustion gas (CG) that has passed through the decomposition reactor 500 exchange heat in the third heat exchanger 900. Accordingly, a heat source of the combustion gas (CG) remaining after supplying heat to the decomposition reactor 500 can be effectively recovered. Also, as the oxidant is heated, the amount of fuel used for a target temperature of the combustion gas in the first combustor 700 can be reduced. Here, it is preferable that the temperature of the oxidant heated by the third heat exchanger 900 should be higher than the temperature of the gaseous ammonia at the inlet of the decomposition reactor 500. The oxidant may be air (atmospheric air), and in this case, a blower 920 that supplies the air to the third heat exchanger 900 may be further included.

Also, in the embodiment, water or steam heated by the heat of the exhaust gas (EG) in the heat recovery steam generator 30 supplies heat to the liquid ammonia or gaseous ammonia. FIG. 4 shows a structure in which steam flows into the vaporizer 300 through a pump from the low-pressure steam generation system 32 or the intermediate-pressure steam generation system 33 (a1 or b1) and water having its temperature lowered by supplying heat to the liquid ammonia in the vaporizer 300 is recovered back to the low-pressure steam generation system 32 or the intermediate-pressure steam generation system 33 (a2 or b2). However, the embodiment is not limited to this, and a location where the water or steam is extracted from the heat recovery steam generator 30, a location where the water or steam is recovered to the heat recovery steam generator 30, etc., may be changed. The water or steam is extracted from the heat recovery steam generator 30 may supply heat to the ammonia in the preheater 200 or superheater 400.

Also, in the embodiment, water or steam heated by the heat of the exhaust gas (EG) in the heat recovery steam generator 30 supplies heat to the water passing through the reboiler 650. FIG. 4 shows a structure in which the steam flows from the low-pressure steam generation system 32 or the intermediate-pressure steam generation system 33 to the reboiler 650 through a pump (a1 or b1) and the water having its temperature lowered by supplying heat to the water discharged from the ammonia regeneration tower 640 in the reboiler 650 is recovered back to the low-pressure steam generation system 32 or the intermediate-pressure steam generation system 33 (a2 or b2).

The foregoing has described that the embodiment includes the heat exchange between the oxidant and the combustion gas (CG) in the third heat exchanger 900, the heat exchange between the liquid ammonia and the steam extracted from the heat recovery steam generator 30 in the vaporizer 300, and the heat exchange between the water discharged from the ammonia regeneration tower 640 and the steam extracted from the heat recovery steam generator 30 in the reboiler 650. However, it goes without saying that one or more heat exchanges may be omitted depending on the embodiment. It can be regarded that all the above-described heat exchanges between the two media are made not by direct contact, but by indirect contact.

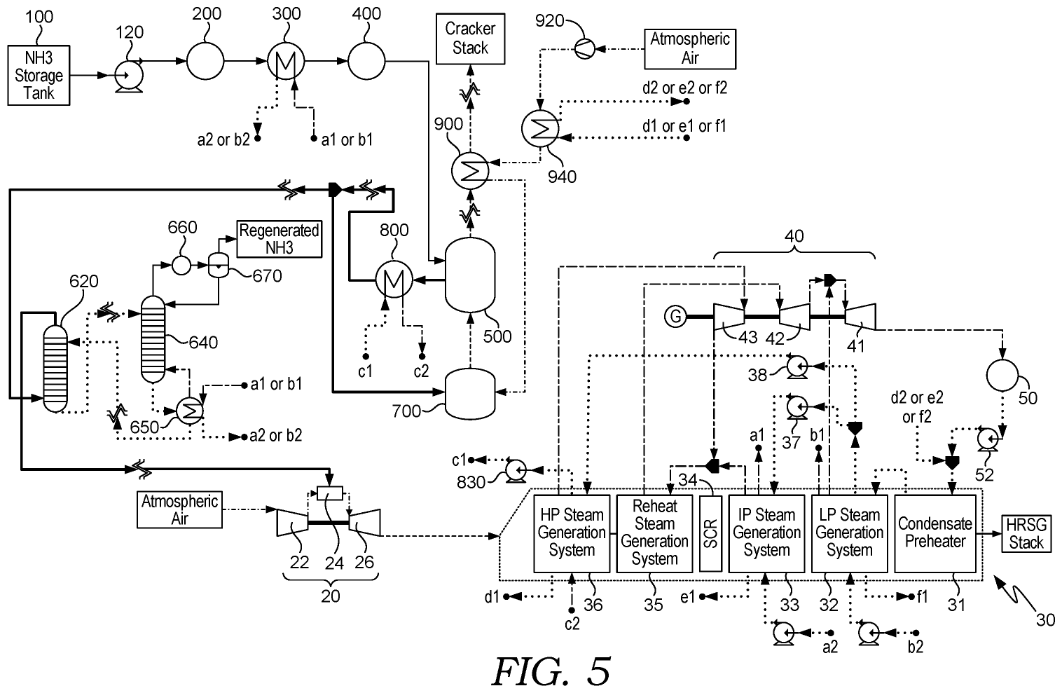

The embodiment shown in FIG. 5 includes all the components of the embodiment shown in FIG. 4, and further includes a fourth heat exchanger 940 in which heat exchange occurs between the oxidant and the water or steam heated by the heat of the exhaust gas (EG) in the heat recovery steam generator 30. That is, the oxidant can be additionally heated by using the water or steam heated by the heat of the exhaust gas (EG) in the heat recovery steam generator 30.

In the embodiment, the third heat exchanger 900 and the fourth heat exchanger 940 are arranged in series, and the oxidant passes through the fourth heat exchanger 940 and the third heat exchanger 900 in turn through the blower 920, and then is supplied to the first combustor 700. However, the embodiment is not limited to this, and the third heat exchanger 900 and the fourth heat exchanger 940 may be arranged in parallel.

FIG. 5 shows a structure in which the water heated by the heat of the exhaust gas (EG) flows from the low-pressure steam generation system 32, the intermediate-pressure steam generation system 33, or the high-pressure steam generation system 36 into the fourth heat exchanger 940 (d1 or e1 or f1) and the water having its temperature lowered by supplying heat to the oxidant in the fourth heat exchanger 940 is recovered downstream of the condenser 50 (d2 or e2 or f2). The water recovered downstream of the condenser 50 is mixed with the water condensed in the condenser 50 and enters the heat recovery steam generator 30. However, the embodiment is not limited to this. A location where the water or steam flowing into the fourth heat exchanger 940 is extracted, a location where the water or steam discharged from the fourth heat exchanger 940 is recovered, etc., may be changed.

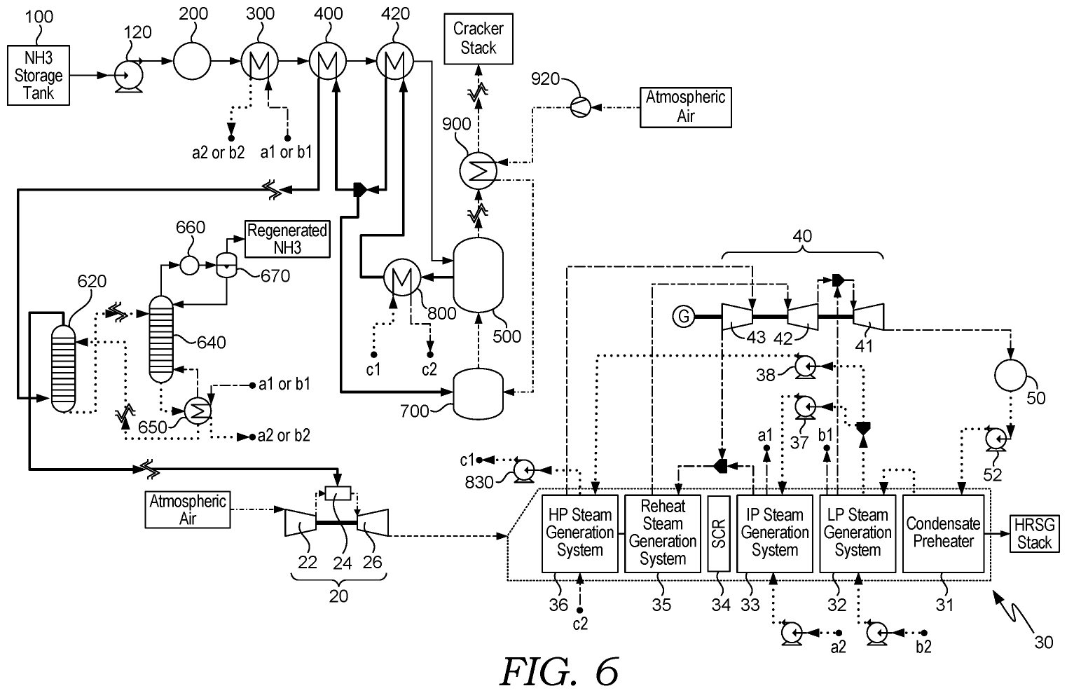

Next, the embodiment shown in FIG. 6 includes the same components as those of the embodiment shown in FIG. 4 and shows that the decomposition gas that has passed through the first heat exchanger 800 is not immediately supplied to the separator 600 but supplies heat to the liquid ammonia or gaseous ammonia, and then is supplied to the separator 600. As a result, a heat source of the decomposition gas (DG) remaining after supplying heat to the first heat exchanger 800 can be effectively recovered. In particular, the decomposition gas (DG) can be used as a heat source of the superheater 400 which requires a high temperature heat source.

Also, the ammonia decomposition system 10 of the embodiment further includes an additional superheater 420 for additionally superheating the gaseous ammonia superheated in the superheater 400. Accordingly, the decomposition gas (DG) that has supplied the heat in the first heat exchanger 800 and has been discharged from the first heat exchanger 800 may pass through the additional superheater 420 and the superheater 400 in turn, and then may be supplied to the separator 600.

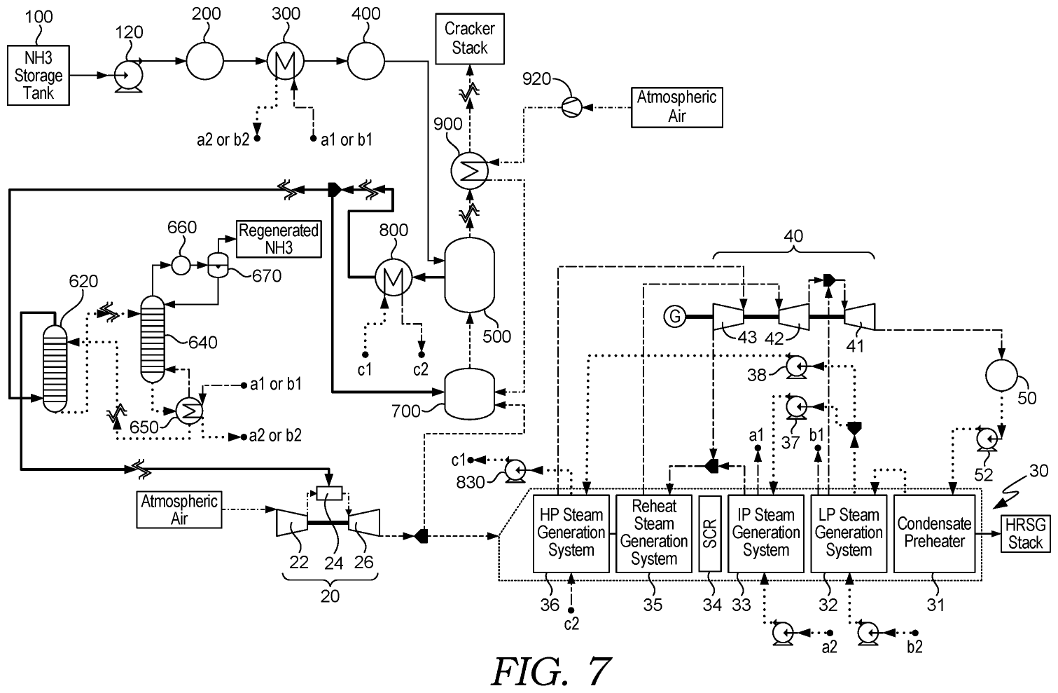

Next, the embodiment shown in FIG. 7 includes the same components as those of the embodiment shown in FIG. 4 and shows that a portion of the exhaust gas (EG) discharged from the gas turbine 20 is supplied as an oxidant to the first combustor 700. Since there is a large amount of residual oxygen in the exhaust gas (EG), the exhaust gas (EG) can be supplied as an oxidant. In this case, a portion or all of the supply amount of the air that is separately supplied as an oxidizer to the first combustor 700 can be replaced, and efficiency can be improved because the temperature of the exhaust gas (EG) is higher than that of the air. For example, when the gas turbine plant is started, the full amount of the air may be supplied as an oxidant to the first combustor 700, and when the gas turbine plant is normally operated, the full amount of the exhaust gas may be supplied as an oxidant to the first combustor 700.

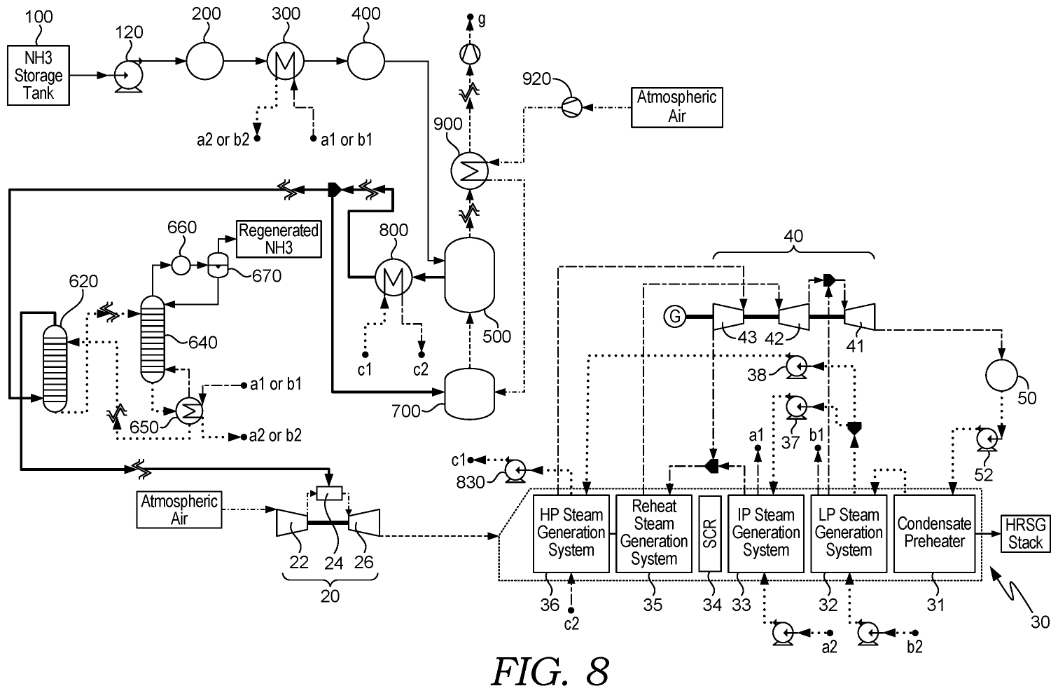

Next, the embodiment shown in FIG. 8 includes the same components as those of the embodiment shown in FIG. 4 and shows that the combustion gas (CG) joins the exhaust gas (EG) within the heat recovery steam generator 30. In the embodiment, since the third heat exchanger 900 is provided, the combustion gas (CG) passes through the decomposition reactor 500 and the third heat exchanger 900, and then flows into the heat recovery steam generator 30 and is mixed with the flow of the exhaust gas (EG). As a result, there is no need for a separate stack for discharging the combustion gas (CG), and the combustion gas (CG) can be discharged together through a stack for discharging the exhaust gas (EG).

In particular, the combustion gas (CG) may join the upstream side of the selective catalytic reduction device 34 in the flow of the exhaust gas (EG) in the heat recovery steam generator 30. As a result, the combustion gas (CG) is treated together with the exhaust gas (EG) in the selective catalytic reduction device 34, thereby reducing nitrogen oxides.

Finally, the embodiment shown in FIG. 8 includes the same components as those of the embodiment shown in FIG. 4 and shows that the water or steam extracted from the heat recovery steam generator 30 or downstream of the condenser 50 receives heat from the combustion gas (CG) in a fifth heat exchanger 1000, and then is recovered to the heat recovery steam generator 30 or upstream of the steam turbine 40. As a result, the heat source of the combustion gas (CG) remaining after supplying heat to the decomposition reactor 500 can be effectively recovered.

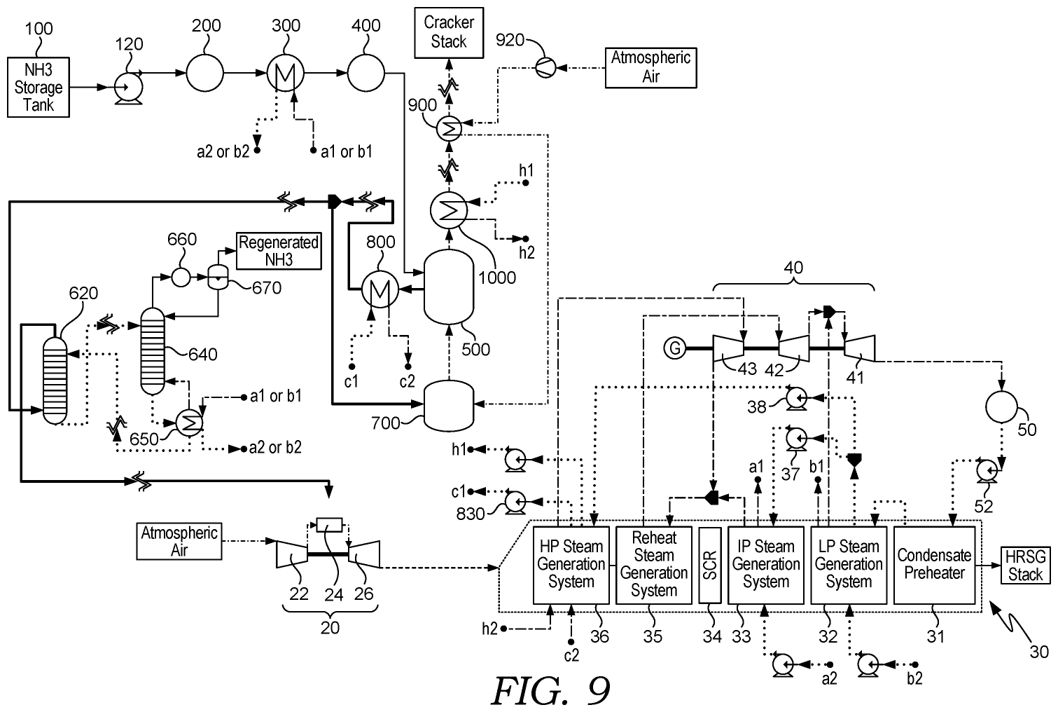

FIG. 9 shows a structure in which water flows from the high-pressure steam generation system 36 to the fifth heat exchanger 1000 through the booster pump (h1) and high-pressure steam heated by the combustion gas (CG) in the fifth heat exchanger 1000 is recovered back to the high-pressure steam generation system 36 (h2). However, the embodiment is not limited to this, and a location where the water or steam flowing into the fifth heat exchanger 1000 is extracted, a location where the water or steam discharged from the fifth heat exchanger 1000 is recovered, etc., may be changed.

Also, depending on the embodiment, the water or steam extracted from the heat recovery steam generator 30 or downstream of the condenser 50 may receive heat from the combustion gas (CG) in the fifth heat exchanger 1000 and then may be supplied to the first heat exchanger 800. Then the water or steam may receive heat from the decomposition gas (DG) in the first heat exchanger 800 and then may be recovered to the heat recovery steam generator 30 or upstream of the steam turbine 40.

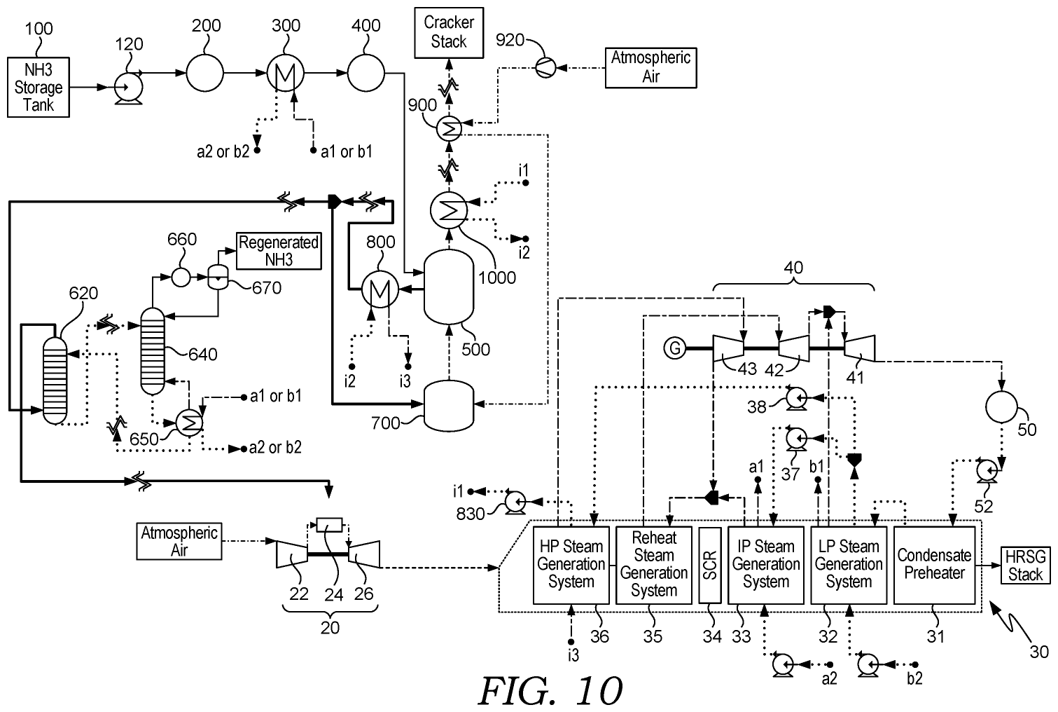

In FIG. 10, water flows from the high-pressure steam generation system 36 to the fifth heat exchanger 1000 through the booster pump (i1) and the water heated by the combustion gas (CG) in the fifth heat exchanger 1000 flows into the first heat exchanger 800 (i2). Subsequently, the high-pressure steam heated by the decomposition gas (DG) in the first heat exchanger 800 is recovered back to the high-pressure steam generation system 36 (i3).

In some cases, the water or steam extracted from the heat recovery steam generator 30 or downstream of the condenser 50 may pass through the first heat exchanger 800 and then may pass through the fifth heat exchanger 1000.

The present invention is not limited to the described specific embodiments and descriptions described above. Various modifications can be made by anyone skilled in the art without departing from the subject matter of the present invention as defined by the appended claims. Such modifications fall within the scope of protection of the present invention.

### REFERENCE NUMERALS

10: Ammonia Decomposition System
20: Gas Turbine
22: Compressor
24: Second Combustor
26: Turbine
30: Heat Recovery Steam Generator
31: Condensate Preheater
32: Low-Pressure Steam Generation System
33: Intermediate-Pressure Steam Generation System
34: Selective Catalytic Reduction (SCR) Device
35: Reheat Steam Generation System
36: High-Pressure Steam Generation System
37: Intermediate-Pressure Pump
38: High-Pressure Pump
40: Steam Turbine
41: Low-Pressure Turbine
42: Intermediate-Pressure Turbine
43: High-Pressure Turbine
50: Condenser
52: Condensate Pump
100: Storage Tank
120: Supply Pump
200: Preheater
300: Vaporizer
400: Superheater
420: Additional Superheater
500: Decomposition Reactor
600: Separator
620: Ammonia Absorption Tower
640: Ammonia Regeneration Tower
650: Reboiler
660: Condenser
670: Separation Tank
700: First Combustor
800: First Heat Exchanger
810: Sprayer
820: Booster Compressor
830: Booster Pump
850: Second Heat Exchanger
900: Third Heat Exchanger
920: Blower
940: Fourth Heat Exchanger
1000: Fifth Heat Exchanger

What is claimed is:

1. A gas turbine plant with an ammonia decomposition system, the gas turbine plant comprising:
a storage tank configured to store liquid ammonia;
a supply pump configured to supply the liquid ammonia of the storage tank;
a preheater configured to preheat the liquid ammonia supplied by the supply pump;
a vaporizer configured to vaporize the liquid ammonia preheated by the preheater;
a superheater configured to superheat the gaseous ammonia vaporized by the vaporizer;
a decomposition reactor configured to thermally decompose the gaseous ammonia superheated by the superheater;
a separator configured to separate residual ammonia from the decomposition gas decomposed by the decomposition reactor; and
a first combustor configured to generate combustion gas in such a way as to supply heat to the decomposition reactor,
wherein synthesis gas consisting of hydrogen and nitrogen with the residual ammonia removed by the separator is supplied to a second combustor of a gas turbine,
wherein exhaust gas that is discharged from the gas turbine is supplied to a heat recovery steam generator, steam generated by heat of the exhaust gas in the heat recovery steam generator is supplied to a steam turbine and drives the steam turbine, and then flows into a condenser, and the water condensed in the condenser is supplied back to the heat recovery steam generator, and
wherein the water or steam extracted from the heat recovery steam generator or downstream of the condenser receives heat from the decomposition gas in a first heat exchanger, and then is recovered to the heat recovery steam generator or upstream of the steam turbine.

2. The gas turbine plant with an ammonia decomposition system of claim 1, wherein the steam recovered upstream of the steam turbine joins the steam generated in the heat recovery steam generator and is supplied to the steam turbine.

3. The gas turbine plant with an ammonia decomposition system of claim 1, further comprising a booster compressor that increases a pressure of the steam extracted from the heat recovery steam generator and supplies the steam to the first heat exchanger.

4. The gas turbine plant with an ammonia decomposition system of claim 1, further comprising a sprayer for spraying water on the steam supplied to the first heat exchanger when the steam extracted from the heat recovery steam generator is supplied to the first heat exchanger.

5. The gas turbine plant with an ammonia decomposition system of claim 4, wherein the sprayer sprays a portion of the water condensed in the condenser on the steam supplied to the first heat exchanger.

6. The gas turbine plant with an ammonia decomposition system of claim 1, further comprising a booster pump that increases a pressure of the water extracted from the heat recovery steam generator and supplies the water to the first heat exchanger.

7. The gas turbine plant with an ammonia decomposition system of claim 1, wherein the water or steam discharged after receiving heat in the first heat exchanger receives additional heat from the decomposition gas in a second heat exchanger.

8. The gas turbine plant with an ammonia decomposition system of claim 7, wherein the decomposition gas discharged from the decomposition reactor passes through the first heat exchanger and then passes through the second heat exchanger.

9. The gas turbine plant with an ammonia decomposition system of claim 1, further comprising a third heat exchanger in which heat exchange occurs between the combustion gas and an oxidant supplied to the first combustor.

10. The gas turbine plant with an ammonia decomposition system of claim 9, further comprising a fourth heat exchanger in which heat exchange occurs between the oxidant and water or steam heated by the heat of the exhaust gas in the heat recovery steam generator.

11. The gas turbine plant with an ammonia decomposition system of claim 10, wherein the oxidant passes through the fourth heat exchanger and the third heat exchanger in turn, and then is supplied to the first combustor.

12. The gas turbine plant with an ammonia decomposition system of claim 10, wherein water or steam extracted from the heat recovery steam generator to the fourth heat exchanger is recovered back to the heat recovery steam generator or downstream of the condenser.

13. The gas turbine plant with an ammonia decomposition system of claim 1, wherein water or steam heated by the heat of the exhaust gas in the heat recovery steam generator supplies heat to the liquid ammonia or the gaseous ammonia.

14. The gas turbine plant with an ammonia decomposition system of claim 1,
wherein the separator comprises:
an ammonia absorption tower that separates the residual ammonia included in the decomposition gas by dissolving the residual ammonia in water; and
an ammonia regeneration tower that evaporates and regenerates ammonia from ammonia water generated by dissolving the residual ammonia in water in the ammonia absorption tower,
wherein a portion of the water discharged from the ammonia regeneration tower is supplied to the ammonia absorption tower, and the rest of the water is vaporized through a reboiler and is supplied back to the ammonia regeneration tower, and
wherein water or steam heated by the heat of the exhaust gas in the heat recovery steam generator supplies heat to the water passing through the reboiler.

15. The gas turbine plant with an ammonia decomposition system of claim 1, wherein the decomposition gas that has passed through the first heat exchanger supplies heat to the liquid ammonia or the gaseous ammonia.

16. The gas turbine plant with an ammonia decomposition system of claim 1, wherein a portion of the exhaust gas is supplied as an oxidant to the first combustor.

17. The gas turbine plant with an ammonia decomposition system of claim 1, wherein the combustion gas joins the exhaust gas within the heat recovery steam generator.

18. The gas turbine plant with an ammonia decomposition system of claim 17, wherein the combustion gas joins an upstream side of a selective catalytic reduction device of the heat recovery steam generator.

19. The gas turbine plant with an ammonia decomposition system of claim 1, the water or steam extracted from the heat recovery steam generator or downstream of the condenser receives heat from the combustion gas in a fifth heat exchanger, and then is recovered to the heat recovery steam generator or upstream of the steam turbine.

20. A gas turbine plant with an ammonia decomposition system, the gas turbine plant comprising:
a storage tank configured to store liquid ammonia;
a supply pump configured to supply the liquid ammonia of the storage tank;
a preheater configured to preheat the liquid ammonia supplied by the supply pump;
a vaporizer configured to vaporize the liquid ammonia preheated by the preheater;
a superheater configured to superheat the gaseous ammonia vaporized by the vaporizer;
a decomposition reactor configured to thermally decompose the gaseous ammonia superheated by the superheater;
a separator configured to separate residual ammonia from the decomposition gas decomposed by the decomposition reactor; and
a first combustor configured to generate combustion gas in such a way as to supply heat to the decomposition reactor,
wherein synthesis gas consisting of hydrogen and nitrogen with the residual ammonia removed by the separator is supplied to a second combustor of a gas turbine,
wherein exhaust gas that is discharged from the gas turbine is supplied to a heat recovery steam generator, steam generated by heat of the exhaust gas in the heat recovery steam generator is supplied to a steam turbine and drives the steam turbine, and then flows into a condenser, and the water condensed in the condenser is supplied back to the heat recovery steam generator, and
wherein the water or steam extracted from the heat recovery steam generator or downstream of the condenser receives heat from the combustion gas in a fifth heat exchanger and then is supplied to a first heat exchanger, and receives heat from the decomposition gas in the first heat exchanger and then is recovered to the heat recovery steam generator or upstream of the steam turbine.
